(19) United States
(12) Patent Application Publication
(10) Pub. No.: US 2008/0073610 A1
(43) Pub. Date: Mar. 27, 2008

(54) STOPCOCK VALVE

(76) Inventors: Casey Patrick Manning, Manchester, NH (US); Philip R. Houle, Sunnyvale, CA (US); William T. Larkins, Manchester, NH (US)

Correspondence Address: HOLLAND & KNIGHT LLP, 10 ST. JAMES AVENUE, 11th Floor, BOSTON, MA, 02116-3889, US

(21) Appl. No.: 11/851,276

(22) Filed: Sep. 6, 2007

Related U.S. Application Data
(63) Continuation-in-part of application No. 11/559,792, filed on Nov. 14, 2006.
Application No. 11/559,792 is a continuation of application No. 11/455,494, filed on Jun. 19, 2006.
Application No. 11/455,494 is a division of application No. 10/803,049, filed on Mar. 16, 2004, now Pat. No. 7,214,210.
Application No. 10/803,049 is a continuation of application No. 10/266,997, filed on Oct. 8, 2002, now Pat. No. 6,726,656.
Application No. 10/266,997 is a continuation of application No. 09/359,232, filed on Jul. 22, 1999, now Pat. No. 6,464,667.
Application No. 09/359,232 is a division of application No. 09/137,025, filed on Aug. 20, 1998, now Pat. No. 6,210,361.
Application No. 09/137,025 is a continuation-in-part of application No. 08/916,890, filed on Aug. 22, 1997, now abandoned.
Application No. 08/916,890 is a continuation-in-part of application No. 08/917,537, filed on Aug. 22, 1997, now Pat. No. 6,165,154.

(51) Int. Cl. F16L 55/027

(52) U.S. Cl. 251/122

(57) ABSTRACT

A stopcock control valve including a valve seat member defining a hollow area, the valve seat member having an aperture and a rigid member having an outer circumferential surface. The outer circumferential surface having a tangential groove defined thereon, the groove tapering, the tapering including sections of varying volume from a large volume to a small volume, wherein the rigid member rotatably fits within the hollow area of the valve seat member.

### CROSS-REFERENCE TO RELATED APPLICATIONS

The present invention is a continuation-in-part of application Ser. No. 11/559,792 filed Nov. 14, 2006 (Attorney Docket No. E66) which is a continuation of application Ser. No. 11/455,494 filed Jun. 19, 2006, which is a divisional of application Ser. No. 10/803,049 filed Mar. 16, 2004, which is a continuation of application Ser. No. 10/266,997, now U.S. Pat. No. 6,726,656 filed Oct. 8, 2002, which is a continuation of application Ser. No. 09/359,232, now U.S. Pat. No. 6,464,667 filed Jul. 22, 1999, which is a divisional of application Ser. No. 09/137,025, now U.S. Pat. No. 6,210,361 filed Aug. 20, 1998, which is a continuation-in-part of application Ser. Nos. 08/916,890 (abandoned) and 08/917,537 (now U.S. Pat. No. 6,165,154) both of which were filed Aug. 22, 1997. All of these above referenced applications and patents are hereby incorporated herein, in their entirety, by reference.

### TECHNICAL FIELD

The present invention relates to apparatus and methods for controlling flow.

### SUMMARY OF THE INVENTION

The invention is directed to a cassette for controlling the flow of IV fluid from a patient to a source. The cassette preferably includes, along the fluid passage through the cassette, first and second membrane-based valves on either side of a pressure-conduction chamber, and a stopcock-type valve. The stopcock valve is preferably located downstream of the second membrane-based valve, which is preferably located downstream of the pressure-conduction chamber.

It is preferred to use a stopcock control valve of the type having a first rigid member (preferably cylindrical) having a first surface (preferably the cylinder's circumferential surface), and a second rigid member (also preferably cylindrical) having a second surface that complements the first surface. The first rigid member defines a first fluid-path portion with a first terminus at the first surface, and the second rigid member defining a second fluid-path portion with a second terminus at the second surface. The first terminus preferably includes a groove defined on the first surface, the groove tapering from a large cross-sectional area to a small cross-sectional area. The first and second rigid members are capable of being rotated with respect to each other from a fully open position continuously through partially open positions to a closed position.

In an improved version of this type of stopcock valve, according the present invention, the first and second surfaces define a space therebetween, instead of having an interference fit typical of prior-art valves. Also, the improved valve includes a resilient sealing member disposed in the space between the first and second surfaces and extending from the second surface to the first surface. The sealing member defines an aperture through which fluid communication is provided between the first and second fluid-path portions when the first and second rigid members are in an open position with respect to each other. The sealing member is sealingly mounted to the second surface so that, when the first and second rigid members are in the closed position with respect to each other, the sealing member provides a seal preventing flow between the first and second fluid-path portions. The sealing member is located with respect to the groove such that, when the first and second rigid members are in a partially open position with respect to each other, fluid flowing between the first and second fluid-path portions flows through the groove as well as the sealing member's aperture. The improved valve further includes seal means disposed with respect to the space defined by the first and second surfaces for preventing flow of fluid out of the space except through the first fluid-path portion. Preferably, the seal means includes an O-ring made of resilient material disposed around the second rigid member's circumference. It is also preferred that the sealing member and the O-ring be formed from a single integral piece of resilient material.

Preferably, the groove, when the first and second members are in at least one partially open position with respect to each other, extends beyond two sides of the sealing member, so that fluid can flow through the sealing member's aperture and in two different directions in the groove.

It is also preferred that the valve be made by molding a resilient material about and to the second rigid member so as to form an aperture sealing member about the port on the complementing surface of the second rigid member, and then assembling the first and second rigid members, which are preferably molded out of rigid material, so as to bring the complementing surfaces adjacent each other and so that the sealing member is urged against the complementing surface of the first rigid surface.

In a preferred version of the cassette, which is primarily made out of rigid material, the membrane for the second membrane-based valve is disposed adjacent the housing, such that the rigid housing and the membrane define a valving chamber. One passage enters the valving chamber at a first mouth located at the end of a protrusion of the rigid housing into the valving chamber towards the membrane, and the valve may prevent the flow of fluid therethrough when the membrane is forced against the first mouth, by the control unit. The control valve restricts the flow of intravenous fluid from the valving chamber to the patient, since it is located downstream of the valving chamber. The membrane defining the valving chamber is preferably large and resilient, so that the valving chamber may provide a supply of pressurized intravenous fluid to the patient, when the first mouth is sealed closed and when there is a restriction downstream of the valving chamber.

For the pressure-conduction chamber, a membrane is preferably disposed adjacent the rigid housing, so as to define a pressure-conduction chamber, wherein the rigid housing portion that defines the pressure-conduction chamber is generally dome-shaped. The membrane has a filled-chamber position, in which position the pressure-conduction chamber is substantially at its greatest volume, and an empty-chamber position, in which position the pressure-conduction chamber is at its smallest volume, and in which position the second membrane rests against the rigid housing and assumes the dome shape of the rigid housing. The second membrane preferably has a structure causing the membrane to be stable in the empty-chamber position but relatively unstable in the filled chamber position. The rigid housing and the second membrane in the empty-chamber position preferably define an unobstructed fluid passageway through the pressure-conduction chamber from the first to the second pressure-conduction chamber mouth. Preferably, the membrane has a structure that causes the second membrane, when its at its full-chamber position, to collapse in the region of the pressure-conduction chamber's outlet mouth before collapsing nearer the inlet mouth. This structure helps force bubbles in the fluid upward toward the inlet mouth and the IV fluid source during a bubble-purge cycle.

These aspects of the invention are not meant to be exclusive and other features, aspects, and advantages of the present invention will be readily apparent to those of ordinary skill in the art when read in conjunction with the appended claims and accompanying drawings.

### BRIEF DESCRIPTION OF THE DRAWINGS

These and other features and advantages of the present invention will be better understood by reading the following detailed description, taken together with the drawings wherein:

FIG. 1 shows a top view of a cassette according to a preferred embodiment A the present invention.

FIGS. 2 and 3 show front and bottom views respectively of the cassette of FIG. 1.

FIG. 4 shows a control unit for receiving and controlling a cassette, such as the cassette of FIGS. 1-3.

FIG. 5 shows a cross-section of the cassette of FIGS. 1-3.

FIG. 6 shows a rear view of the cassette and shows the fluid paths through the cassette.

FIG. 7 shows a front view of the middle rigid panel of the cassette of FIGS. 1-3.

FIGS. 8 and 9 show side and rear views respectively of the middle panel of FIG. 7.

FIG. 10 shows a partial cross-section of the middle panel of FIG. 7.

FIG. 11 is a cross-sectional detail of the control valve of the cassette according to a preferred embodiment of the invention.

FIG. 12 shows a side view of an outer cylinder (a valve-seat member) having rigid and resilient elements that may be used in the control valve.

FIG. 13 shows a cross-sectional view of the cylinder of FIG. 12.

FIG. 14 depicts the relationship between the aperture of the FIG. 12 cylinder and the groove used in the control valve.

FIG. 15 shows a cross-sectional view of the membrane used in the pressure-conduction chamber of the present invention.

FIGS. 16 and 17 show front and rear views respectively of the FIG. 15 membrane.

FIG. 18 shows a front view of the membrane used in the valve located downstream of the pressure-conduction chamber and upstream of the control valve.

FIG. 19 shows a cross-section of the FIG. 18 membrane.

FIG. 20 is a schematic representing how the compliant membrane of FIG. 18 may be used to regulate the pressure of fluid to the patient.

FIG. 21 is a graph depicting the advantage of using a compliant membrane such as that shown in FIG. 18.

FIGS. 22 and 23 depict the preferred shape of the inlet valve to the pressure conduction chamber.

FIG. 24 shows a cross-sectional view of the inlet valve to the pressure conduction chamber.

FIG. 25 shows a preferred arrangement of teeth around the circumference of the control wheel.

FIG. 26A is an isometric view of the rigid member.

FIG. 26B an isometric view of the rigid member.

FIG. 27A is an isometric view of the valve seat member.

FIG. 27B is an isometric view of the valve seat member.

FIG. 28A is an isometric view of the seal.

FIG. 28B is an isometric view of the seal.

FIG. 29A is a bottom view of the motor.

FIG. 29B is a top view of the motor.

FIG. 30 is an exploded view of the motor, rigid member, the seal and valve seat member.

FIG. 31 is an exploded view of the motor, rigid member, the seal and valve seat member.

FIG. 32 is an exploded view of the motor, rigid member, the seal and valve seat member showing hidden lines.

FIG. 33 is a back view of the complete assembly shown in FIGS. 30-32.

FIG. 34 is a side view of the complete assembly shown in FIGS. 30-32.

FIG. 35 is a front view of the complete assembly shown in FIGS. 30-32.

### DETAILED DESCRIPTION OF SPECIFIC EMBODIMENTS

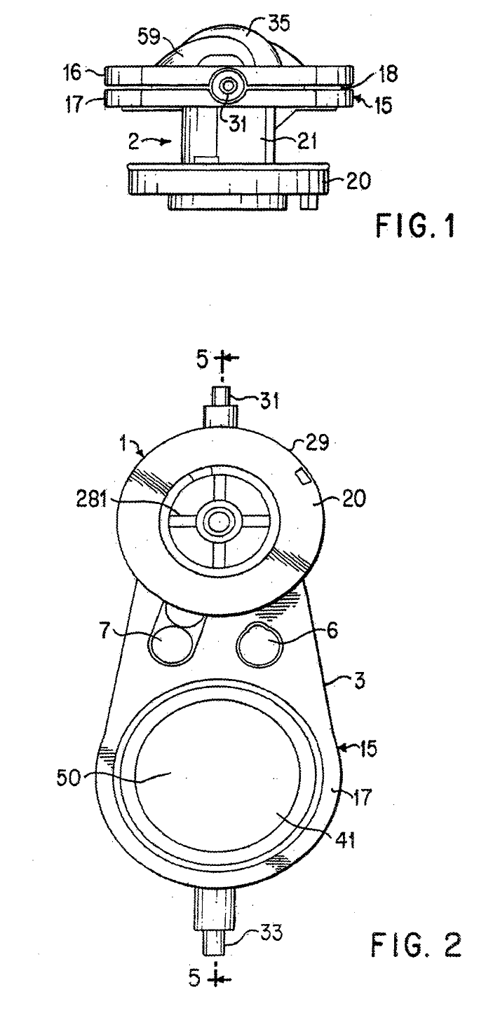

The present invention includes a cassette for use in a system for controlling the flow of IV fluid to a patient, along the lines of the cassettes disclosed in U.S. Pat. Nos. 5,088,515 and 5,195,986. A preferred embodiment of the cassette is depicted in FIGS. 1-3, which respectively depict top, front and bottom views of the cassette. The cassette is used in a control unit, such as that described in application Ser. No. 08/472,212, now U.S. Pat. No. 5,772,637, which is hereby incorporated by reference herein in its entirety, which is similar to the control unit described in U.S. Pat. No. 5,088,515, which describe the use of pressure, preferably pneumatic pressure, for controlling the actuation of valves and the urging of fluid into and out of a pressure-conduction chamber.

In addition to performing the function of a pump urging fluid through the IV line, the pressure-conduction chamber can measure the amount of IV fluid being delivered to the patient as well as detect the presence of bubbles in the IV fluid in the pressure-conduction chamber. Preferred methods of detecting and eliminating air bubbles from the IV fluid are discussed in patent application Ser. Nos. 08/477,380 and 08/481,606, now U.S. Pat. Nos. 5,641,892 and 5,713,865, respectively, which are hereby incorporated by reference herein in their entirety. FIG. 4 depicts a preferred version of a control unit 10. Control unit 10, which has a user-interface panel 103 containing a key pad and a display so that the status of the IV fluid delivery may be monitored and modified by medical personnel. The cassette is slipped behind door 102, and by turning handle 101 the door is pressed against the cassette, which in turn is then pressed against the main housing of the control unit 10. The main housing 104 preferably includes mechanical means for actuating membrane-covered valves and for applying a pressure against the membrane of the pressure-conduction chamber. The main housing 104 also includes means for turning the control wheel of the cassette.

Referring to FIG. 2, the main components of the preferred embodiment of the cassette are a first membrane-based valve 6, a pressure-conduction chamber 50, a second membrane based valve 7 and a stopcock-type control valve 2. Valve 6 controls the flow to the pressure-conduction chamber 50 from the inlet 31 to the cassette, which is connected to an IV line, which in turn is connected to a source of IV fluid. The second membrane-based valve 7 and the control valve 2 together are used to control the flow of fluid from the pressure-conduction chamber 50 to the outlet to the cassette 33, which is connected to the IV line leading to the patient.

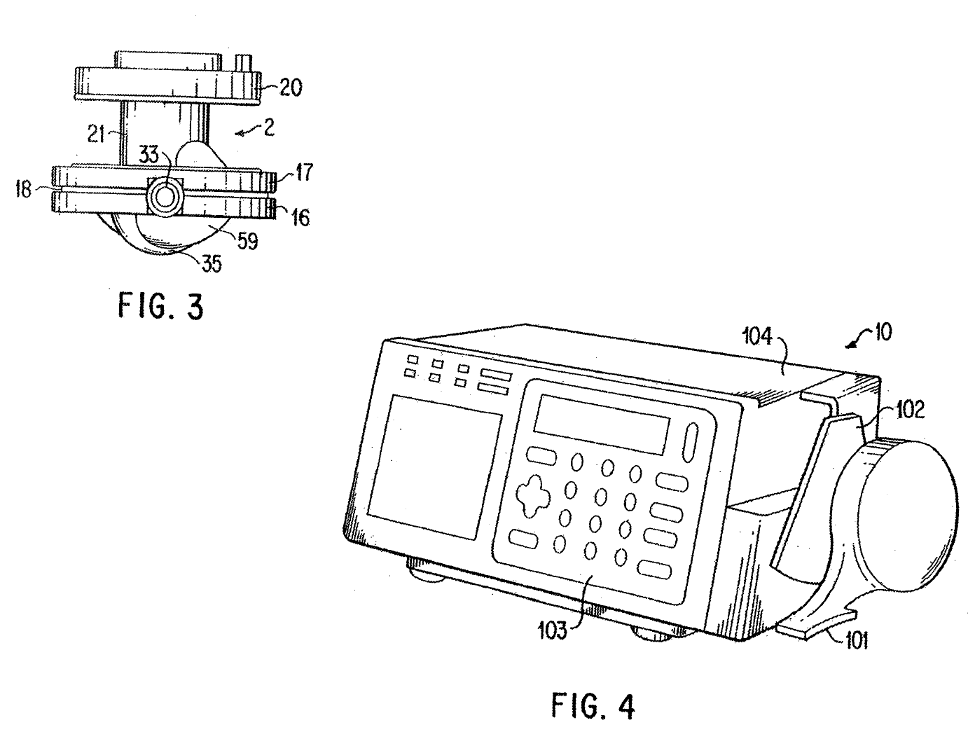

The rigid housing 15 of the cassette is made primarily from three rigid panels. A front panel 17, a middle panel 18, and a rear panel 16, all three of which can be seen in FIGS. 1 and 3. The front panel is preferably molded integrally with the outer collar 21 of the control valve 2. The wheel 20 of the control valve 2 preferably includes ribs 281 and/or teeth mounted along the circumference 29 of the knob 20. (FIG. 25 shows a preferred arrangement of teeth around the circumference 29 of the control knob 20.) The teeth and/or ribs 281 may be engaged by the main housing 104 of the control unit 10, so that the control unit 10 may change the resistance that the control valve 2 exerts on the IV fluid passing through the valve.

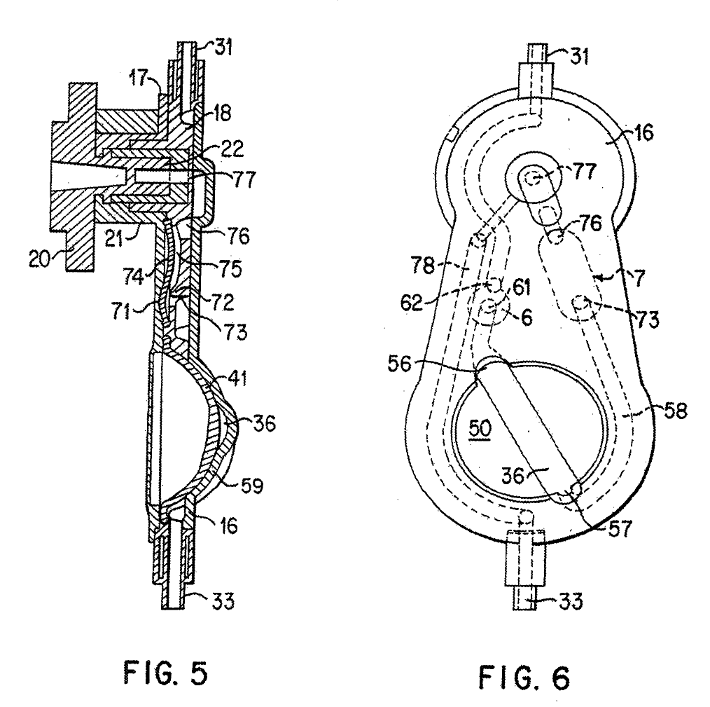

The cassette may also be used without the control unit 10. In that case, the control wheel 20 may be turned by hand. When disengaged from the control unit 10, the membrane of the pressure-conduction chamber 50 is preferably collapsed so that it rests against the rigid rear wall 50 of the pressure-conduction chamber 50. With the membrane in this collapsed state, IV fluid may still easily flow through the pressure-conduction chamber 50 through a raised portion 35 of the rear wall 59. This raised portion 35 defines a conduit 36 leading from the inlet mouth of the pressure conduction chamber 50 to the outlet mouth of the pressure conduction chamber, as can be seen in FIG. 4. FIG. 6 shows the fluid paths leading through the cassette. As noted above, fluid enters the cassette through the inlet 31, whence it flows through a fluid path to valve 6. The fluid then enters the valving chamber of valve 6 through a port 62. The outlet port 61 is preferably mounted on a protrusion so that pressure from the pressure-conduction chamber 50 is less likely to force the membrane to lift from the outlet valve 61. From valve 6 the fluid passes to the inlet mouth 56 of the pressure-conduction chamber 50. The pressure-conduction chamber is seen in the cross-sectional view of FIG. 5. A membrane 41 allows pressure from the control unit 10 to be applied to the fluid in the pressure-conduction chamber 50 without the fluid coming into contact with the control unit 10. When the membrane 41 is in its collapsed position resting against rigid wall 59, as shown in FIG. 5, fluid can still pass from inlet valve 56 through conduit 36 to the outlet valve 57. After passing through the pressure-conduction chamber 50, the fluid flows to the second membrane-based valve 7, which included an inlet mouth 73, which is mounted on a protrusion like the outlet mouth of the first membrane-based valve 6. The second membrane-based valve's inlet mouth 73 and the protrusion 72 on which it is mounted can be seen in the cross-sectional view of FIG. 5. Like the outlet mouth 61 of the first membrane-based valve, the inlet mouth 73 may be closed by the application of pressure by the control unit 10 on a membrane; the portion of the membrane 71 that closes off the inlet valve 73 can be seen in FIG. 5. After passing through the outlet mouth 76 of the second membrane-based valve, the fluid passes to the inlet 77 of the stopcock-type control valve, which inlet can be seen in both FIGS. 5 and 6. After passing through the control valve and the fluid path 78 exiting from the control valve, the fluid passes to the outlet of the cassette 33 and to the IV line leading to the patient.

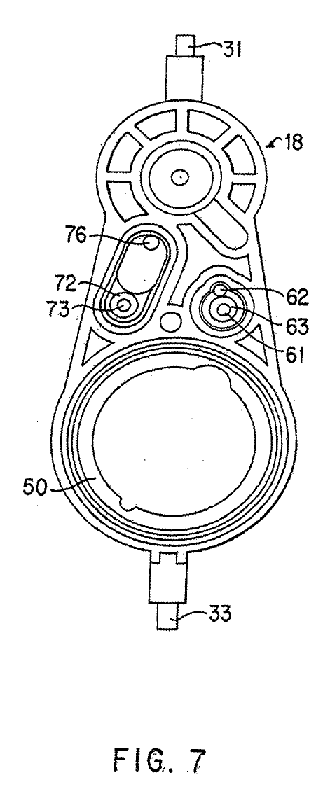

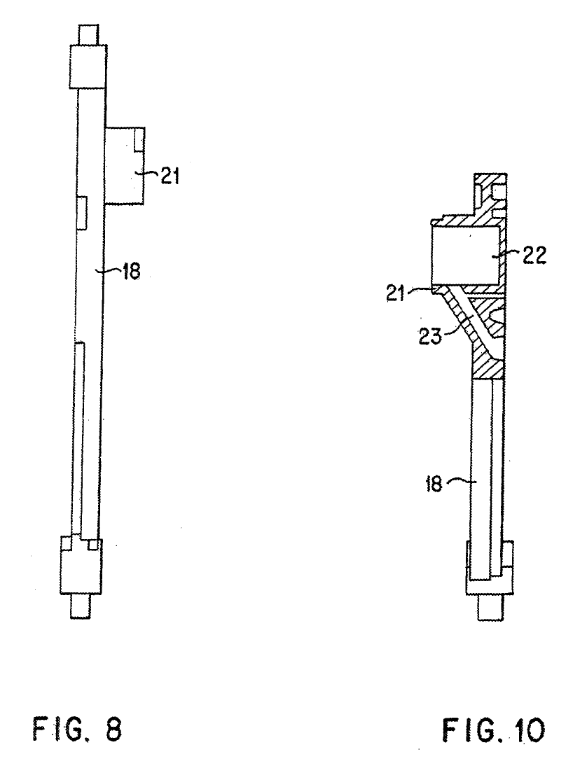

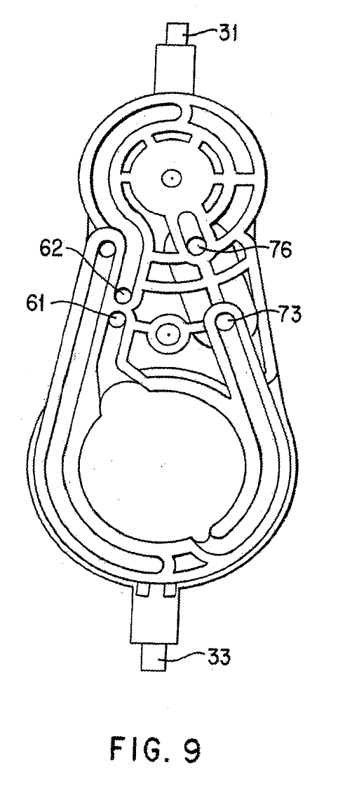

FIG. 7 shows a front view of the rigid middle panel 18 of the cassette, and FIG. 8 shows a side view of the middle rigid panel 18. The middle rigid panel 18 defines the cassette inlet 31 and outlet 33, a circumferential portion of the pressure-conduction chamber 50, and the inlet and outlet ports 62, 73, 61 and 76, of the two membrane-based valves 6 and 7. The protrusions 63 and 72 of the ports 61 and 73 can also be seen in FIG. 7. FIG. 9 shows a rear view of the middle rigid portion shown in FIGS. 7 and 8. The ports 61, 62, 73, 76 can also be seen in FIG. 9. FIG. 10 shows a partial cross-section of the middle rigid portion. The cross-section shows the outer collar 21 of the control valve, which is integrally molded with the rest of the middle rigid portion. The outer collar 21 defines a hollow area 22′ and a fluid path 23 leading from the hollow area 22′.

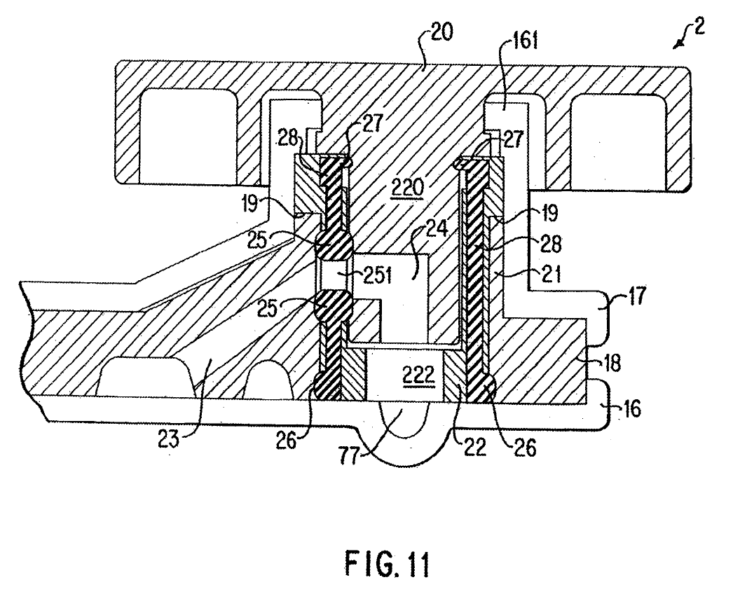

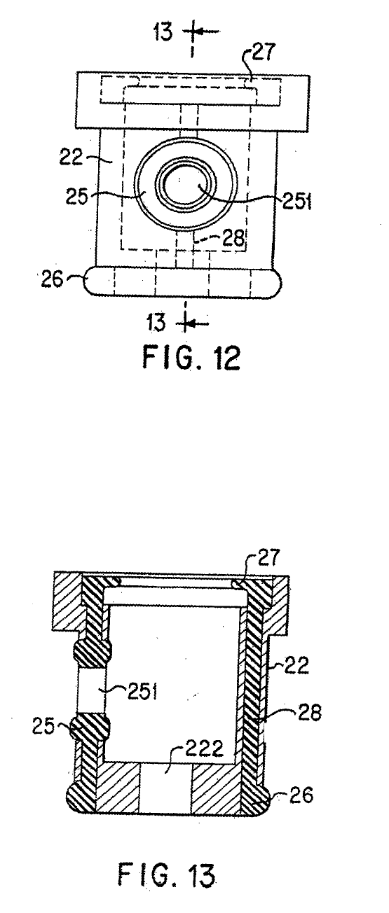

FIG. 11 shows a cross-section of an assembled control valve 2 that may be used in a cassette according to the present invention. Just inside of the outer collar 21 is a valve-seat member 22 fixedly attached to the outer collar 21 so that the valve-seat member 22 does not rotate with respect to the rest of the cassette. The valve-seat member 22 is depicted in greater detail in FIG. 12 and in cross-section in FIG. 13. The valve-seat member 22 also defines a hollow area, which accepts the shaft 220 of the control wheel 20, so that the control wheel's shaft 220 rotates with the control wheel 20. The valve-seat member 22 is comprised mostly of rigid material, but importantly it also includes molded-over resilient material, which is used to form sealing O-rings. This resilient material forms an O-ring 26 around the base of the valve-seat member 22; the rigid portion of the base defines a passage 222, connecting the valve inlet 77 to passage 24. The resilient material 25 also provides a seal around an aperture 251 in the circumferential surface of the member 22. At the end of the member 22 opposite the inlet passage 222 is an inner O-ring 27 which forms the seal between the control wheel's shaft 220 and the valve-seat member 22. The O-ring 26 around the exterior circumference of the base provides a seal between the outer circumferential wall of the valve-seat member 22 and the inner circumferential wall of the outer collar 21. Likewise, the O-ring 25 around the circumferential port 251 may provide a seal between the outer circumferential wall of the valve-seat member 22 and the inner circumferential wall of the outer collar 21. Together, O-rings 25, 26 prevent fluid from leaking between the valve-seat member 22 and the outer collar 21. Importantly, the O-ring 25 of port 251 also provides a seal between the valve-seat member 22 and the shaft 220, so that when the valve is in the fully closed position no flow is permitted between passageway 24 of shaft 220 and the port 251 of the valve-seat member 22.

The advantage of this design over previous stopcock valves is that the outer diameter of the shaft 220 may be slightly less than the inner diameter of the valve-seat member 22, whereas previous stopcock valves required an interference fit between the inner and outer components. It will be appreciated that the stopcock valve of the present invention may use frusto-conical-shaped members instead of cylindrical members. The interference fit of prior-art devices created a great deal of resistance when the stopcock valves were turned. The use of O-rings in the stopcock valve of the present invention avoids the need for this interference fit and the greater torque required for turning the valve resulting from the interference fit. O-ring 27 prevents leaking from the space between the valve-seat member 22 and the shaft of the control wheel 20.

The valve-seat member is preferably made in a two-part molding process, wherein the rigid portion is first molded and then the softer resilient material is over-molded onto the rigid portion. Channels may be provided in the initially molded rigid portion so that the resilient material may flow to all the desired locations; this results in columns of resilient material 28 connecting the areas of resilient material through these channels. The valve-seat member 22 is preferably molded separately from the rest of the cassette, and when the cassette is assembled the valve-seat member 22 is placed in the hollow area 22′ defined by the outer collar 21 of the middle panel 18, and aligned so that aperture 251 lines up with passageway 23. (The shape of the outer diameter of the valve-seat member 22 and the inner diameter of the outer collar 21 may be complementarily shaped so that the valve-seat member must align properly with the aperture 251 and the passageway 23 lines up.) Then, the front rigid panel 17 is ultrasonically welded (along with the rear rigid panel 16) to the middle rigid panel 18, and the valve-seat member 22 is then held in place in the hollow area defined by the outer collar 21. The outer circumference of the valve-seat member 22 may be a bit smaller than the inner diameter of the outer collar 21; O-rings 25, 26 prevent fluid from flowing from the passages 77 or 23 to point 19. This design of the valve-seat member 22 avoids the need for tight tolerances in the various components of the valve 2. The control wheel's shaft 220 may be inserted into the hollow area defined by valve-seat member 22 after the rest of the valve has been assembled. The shaft 220 is held in place by a lip 161 around the inner circumference of the hollow area defined by the rear rigid panel 16.

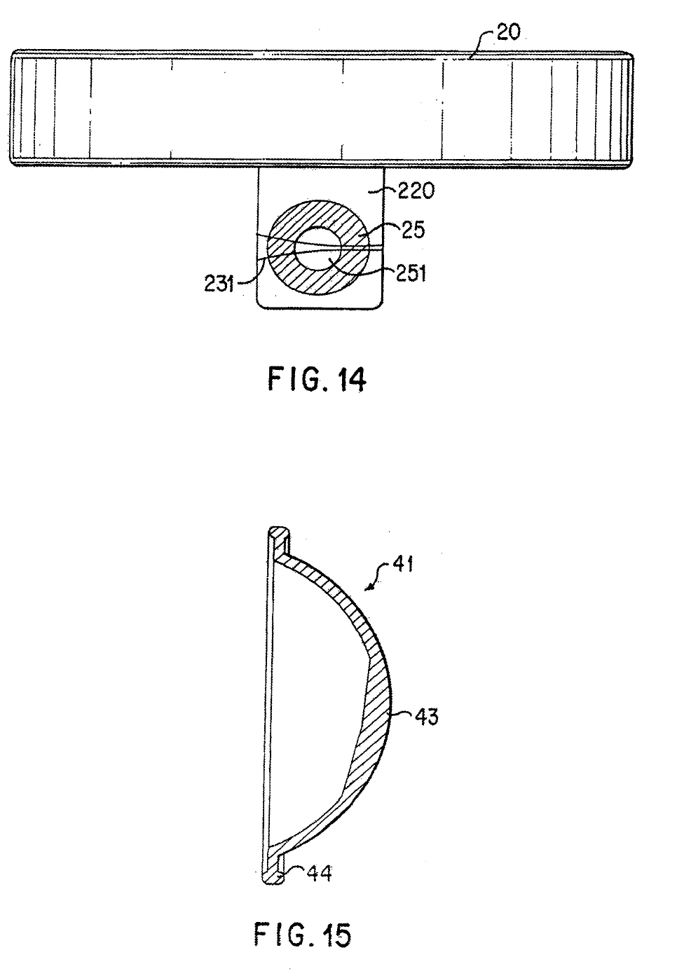

When the valve 2 is fully opened, the circumferential aperture 251 is lined up with the fluid passage 24 in the shaft 220. When the valve is fully closed there is no fluid communication between the aperture 251 and the fluid passage 24. The outer circumferential surface of the shaft 220 preferably includes a groove extending circumferentially around the shaft's outer circumferential wall from the terminus of the fluid passage 24 at the outer circumferential wall; the groove tapers in cross-sectional area and does not extend all the way around the outer circumference of the shaft 220. The groove provides greater control of the flow rate. FIG. 14 shows the respective locations of the groove 231, which is located on the outer circumference of the shaft 220 and the circumferential aperture 251 of the valve seat member 22. As the aperture 251 rotates to the right, in the FIG. 14 perspective, the resistance to flow increases, until the groove 231 ends and the aperture 251 loses fluid communication with the groove 231, at which point flow is completely shut off through the control valve 2. As the aperture 251 rotates to the left, in the FIG. 14 perspective, the resistance to flow decreases. Preferably, the groove 231 is longer than the diameter of the aperture 251, so that the flow rate may be controlled more finely.

As noted above, the cassette may be used independently of the control unit 10. When the cassette is used in this manner it is preferable that the membrane 41 rest against the rigid back 59 of the pressure-conduction chamber 50 so as to minimize the volume of the conduit 36 for fluid passing through the pressure conduction chamber 50. If the membrane 41 were too flexible and the volume of the pressure-conduction chamber 50 varied widely, medical personnel would be unable to rely on a quick visual inspection of the rate of dripping in the drip chamber to indicate a steady, desired flow rate through the IV line. Thus, it is desired that the structure of the membrane 41 be such that it tends to rest against wall 59 unless and until a sufficient pressure differential is created across the diaphragm 41. This pressure differential is preferably caused by a negative gas pressure caused by the control unit 10. Although it is desired to manufacture the diaphragm 41 so that it has some tendency to rest against wall 59, it is desired to make the diaphragm 41 so floppy in the other direction so that less pressure is required to move it from its position when the pressure-conduction chamber 50 is full, the “filled-chamber” position. It is also desired that the measurement gas provided by the control unit 10 against the outer face of the membrane 41 be at substantially the same pressure as the fluid on the inner side of the membrane 41 in the pressure-conduction chamber 50.

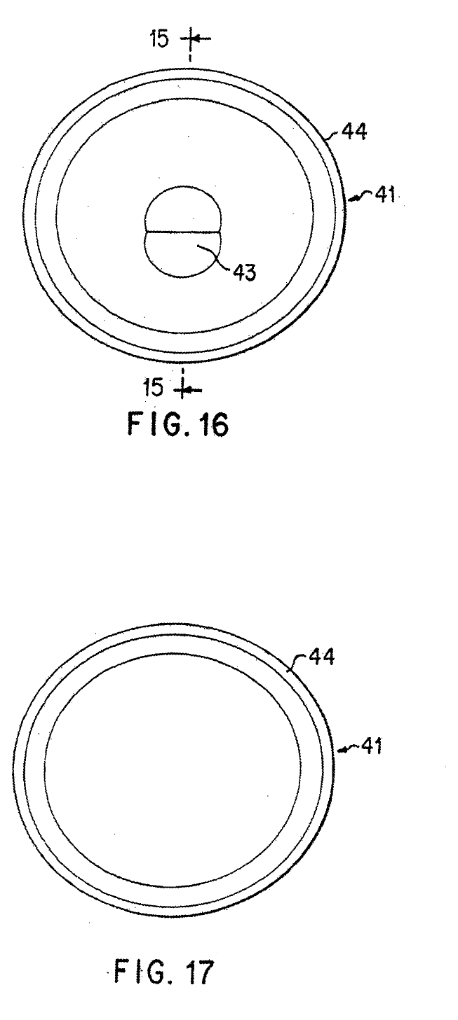

By molding the diaphragm 41 in the shape of a dome corresponding to that of the rigid wall 59, the diaphragm will have a tendency to remain in its position, as shown in FIG. 5, resting against wall 59 when the chamber 50 is at its lowest volume, the “empty-chamber” position. However, when the diaphragm 41 is molded in this way, it also tends to remain in the filled-chamber position, in other words, when the diaphragm 41 is bulging convexly outward from the cassette. The convex, filled-chamber position can be made unstable by adding additional material on the outer, usually concave surface of the diaphragm 41. This additional material 43 can be seen in the cross-section of a preferred embodiment of the diaphragm as shown in FIG. 15. The diaphragm 41 shown in FIG. 15 is molded in the position shown and has a tendency to remain in that position. When the chamber is filled with fluid, the normally concave side of the diaphragm becomes convex, and the additional material 43 is subject to an additional amount of strain since it is at the outer radius of this convex, filled-chamber position. The diaphragm 41 shown in FIG. 15 also includes an integrally molded O-ring 44 around its circumference for mounting and sealing the diaphragm 41 in the cassette. FIG. 16 shows a view of the exterior side of the diaphragm 41 of FIG. 15. This surface of the diaphragm 41 is normally concave when the diaphragm is in the empty-chamber position. The additional material 43 can be seen in the view of FIG. 16. FIG. 17 shows the interior side of the diaphragm 41 of FIG. 15. This side is normally convex when the diaphragm 41 is in the empty-chamber position. Thus, as a result of molding the diaphragm so that its inner surface has a smooth constant radius and the outer surface has additional material, which thereby interrupts the smoothness and constant radius of the rest of the outer face of the diaphragm, the diaphragm 41 has the desired tendency to remain in the empty-chamber position while being unstable in the filled-chamber position.

By positioning this additional material 43 near the outlet mouth 57 of the pressure-conduction chamber 50, the collapse of the diaphragm 41 from its filled-chamber can be somewhat controlled so that the diaphragm tends to collapse first and the lower portion of the pressure-conduction chamber near the outer mouth 57 before further collapsing in the upper region of the pressure conduction chamber nearer the inlet mouth 56. The cassette is preferably mounted in the control unit with a slight tilt so that the passage 36 is vertical and the inlet mouth 56 is at the very top of the chamber 50 and the outlet mouth 57 is at the very bottom of the chamber 50. This orientation permits the bubbles that may be present in the chamber 50 to gravitate towards the inlet mouth 56, which is at the top of the chamber. In a preferred method of eliminating the bubbles from the IV fluid, as described in application Ser. No. 08/481,606, now U.S. Pat. No. 5,713,865, any bubbles that are detected by the control unit in the pressure conduction chamber 50 are forced by pressure from the control unit against the external surface of the membrane 41 up to the inlet mouth 56 to the cassette inlet 31 up the IV line to the fluid source, sometimes after several purging and filling cycles. When purging the bubbles from the chamber 50 through the inlet mouth 56 it is preferred that the chamber collapse at its bottom first so that the membrane does not interfere with bubbles moving upwards through the chamber 50.

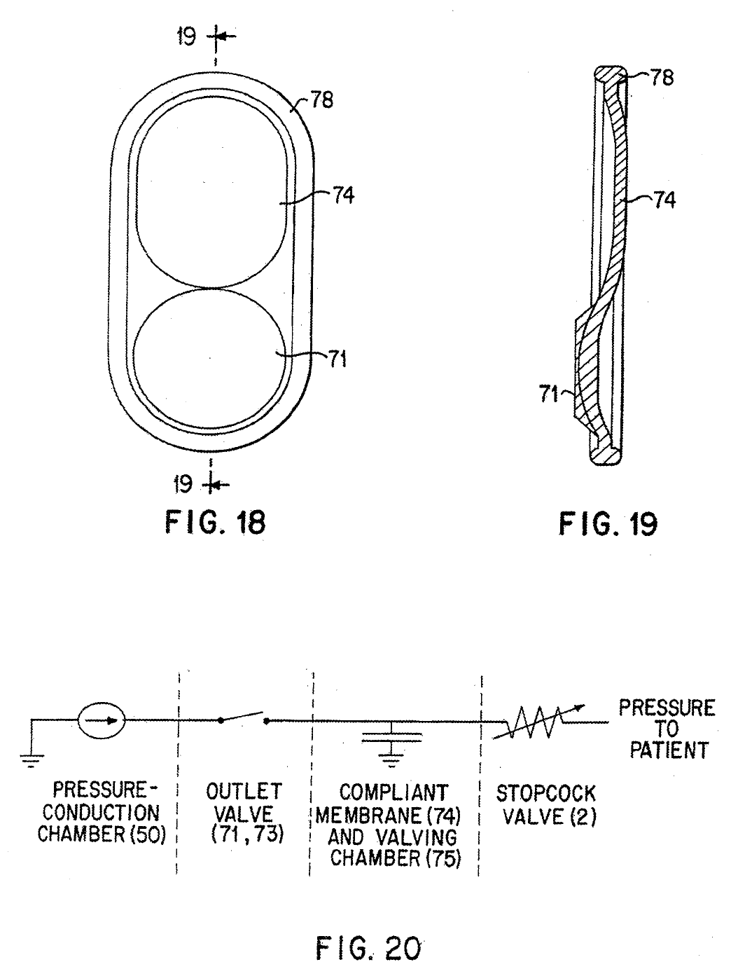

FIGS. 18 and 19 show a preferred membrane design for the second membrane-based valve 7. This membrane has an O-ring 78 for mounting and sealing the membrane onto the cassette (like the lip 44 on the membrane 41 for the pressure-conduction chamber, and like the circular membrane, which is not shown, for the first membrane-based valve 6). This membrane has a first portion 71, which is used to seal off the mouth 73 located on protrusion 72 (see FIG. 5). The control unit 10 exerts a pressure against this portion of the membrane 71 mechanically, in order to close off the valve. The second portion 74 of the membrane is sufficiently compliant so that when the control valve 2 is sufficiently restricting flow out of the outlet 76 of the second membrane-based valve 7 the compliant portion 74 of the membrane will expand outwardly so as to hold under pressure a volume of IV fluid. This design is desirable so that when the inlet mouth 73 is closed, because the pressure-conduction chamber needs to be refilled, the fluid stored in the valving chamber (item 75 in FIG. 5) is available to be dispensed through the control valve 2.

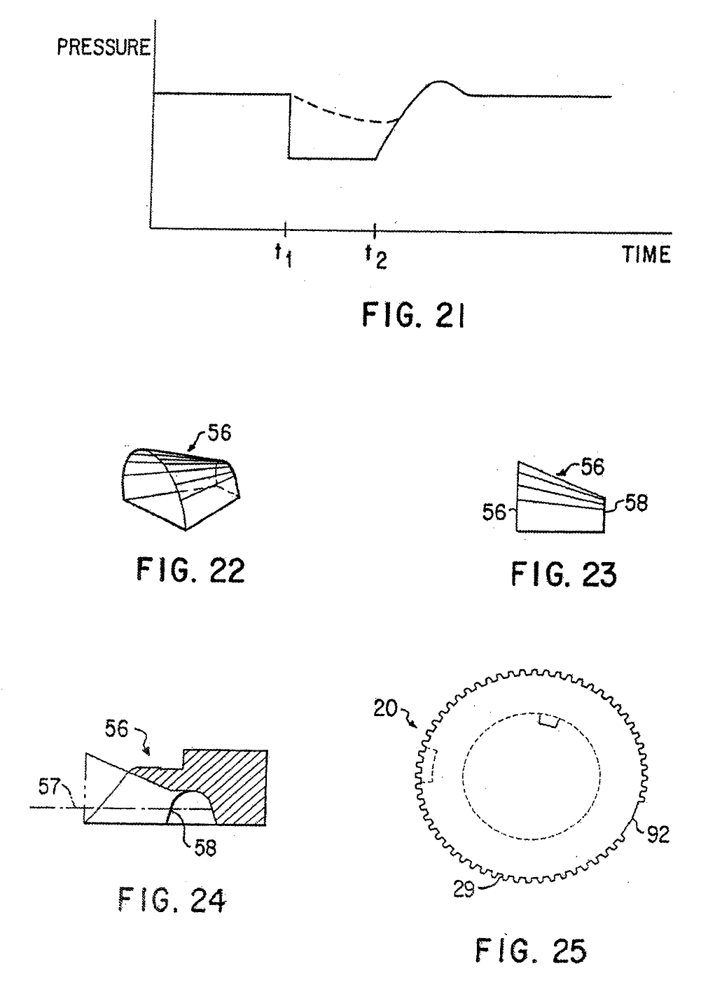

FIG. 20 shows a schematic for an electrical model of the operation of the second membrane-based valve 7 working in conjunction with the stopcock-type control valve 20. When the valve leading from the outlet 57 of the pressure-conduction chamber 50 is open, permitting flow from the pressure-conduction chamber through valve 7, and if the stopcock valve is set to provide a large amount of resistance to the flow from valve 7 to the patient, the valving chamber 75 and its corresponding membrane portion 74 can accumulate a “charge” of fluid, much like a capacitor, as shown in FIG. 20. When membrane 71 is then urged against mouth 73 closing off flow from the pressure-conduction chamber 50, the charge of fluid in the valving chamber 75 is urged by the compliant membrane 74 to continue flow through the stopcock valve 20. As fluid exists the valving chamber 75, the pressure of the fluid decreases as the compliant portion 74 of the membrane returns to its unstretched state. FIG. 21 shows a graph depicting the pressure of the IV fluid being delivered to a patient over time as outlet valve 71, 73 is closed at time t.sub.1 and reopened at t.sub.2. A solid line depicts the pressure to the patient without a compliant membrane 74 design. With a compliant membrane 74, the sharp drop off in pressure at t.sub.1 is eliminated or ameliorated. If the stopcock valve is nearly closed so that only a small trickle of fluid is allowed to flow through it the design of the compliant membrane 74 will greatly smooth out the delivery of fluid, as long as the time between t.sub.1 and t.sub.2 is not too long. When the stopcock valve 2 is fully open a sharp drop in pressure may still be expected at time t.sub.1.

As noted above (and as described in application Ser. No. 08/481,606, now U.S. Pat. No. 5,713,865), when an air bubble is being purged from the pressure-conduction chamber 50, it is preferably forced up through the chamber's inlet valve 56 (which in this air-elimination mode is acting as an outlet). Preferably, the inlet port 56 is shaped so that a small bubble will not tend to stick to an edge of the port while allowing liquid to flow past it. To prevent such sticking of a small bubble, the port 56 preferably flares out so that the corner where the port 56 meets the inner wall of the pressure-conduction chamber 50 is greater than 90.degree., making the corner less likely a place where the bubble will stick. However, the mouth of the port 56 cannot be so large that liquid can easily flow by the bubble when fluid is exiting the pressure-conduction through the port 56. In order to accomplish this, the port must be sized and shaped so that the surface tension of the IV fluid being forced upward from the pressure-conduction chamber 50 forces a bubble located at the port 56 up through the inlet valve 6. It is also preferable that the port 56 be sized and shaped so that when liquid is pulled back into the pressure-conduction chamber 50, the bubble can hover near the port as liquid passes around it. A preferred inlet port 56 shape is shown in FIGS. 22 and 23. The port's size increases from the end 57 that connects to the IV line's upper portion to the end 58 leading into the pressure-conduction chamber. FIG. 24 shows a cross-section of the inlet valve 56. It has been found that providing an inlet portion to the pressure-conduction chamber with this shape improves the air-elimination system's ability to purge bubbles from the chamber. Using a port such as that shown in FIGS. 22-24 in conjunction with the membrane 41 of FIGS. 15-17 helps force bubbles more quickly out of the pressure-conduction chamber when attempting to purge the bubbles back through the cassette's inlet 31 to the IV source.

FIG. 25 shows a preferred arrangement of teeth around the circumference 29 of the control wheel 20. The teeth provide means for a gear in the control unit 10 to engage securely the control wheel's circumference—in particular, a gear that is used to prevent the free flow of fluid through the cassette when the cassette is removed from the control unit 10. When the door 102 of the control unit 10 is being opened, the gear turns the control wheel 20 to close the stopcock-type valve 2, thereby stopping all flow through the cassette and preventing free flow. To ensure that the gear does not continue turning the wheel 20 one the valve 2 has been closed off entirely, a sector 92 along the wheel's circumference is left free of teeth. When the wheel 20 is turned enough so that the gear is adjacent this toothless sector 92, the valve 2 is fully closed. The lack of teeth prevents the gear from continuing to turn the wheel; thus, the wheel cannot be turned too much.

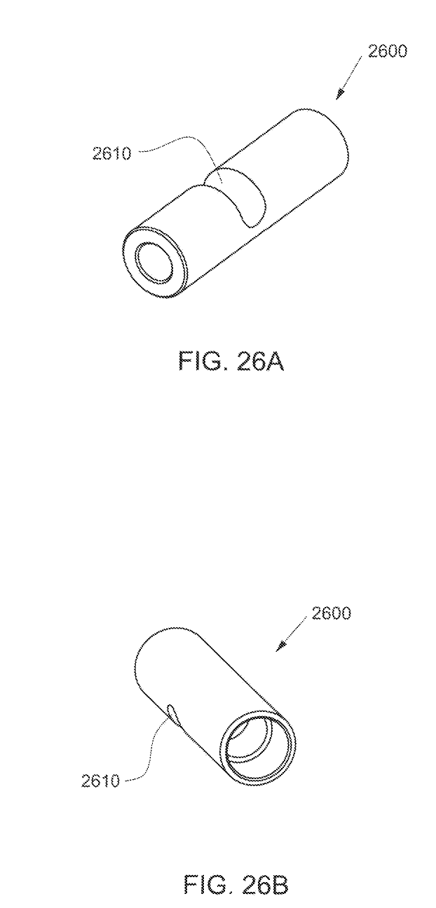

Referring now to FIGS. 26A-26B, the rigid member 2600 is shown. The rigid member 2600 includes a groove 2610 tangential to the member circumference. In one embodiment, the rigid member 2600 is made from stainless steel, however, in other embodiment; the rigid member 2600 can be made from any rigid and/or compliant material. The groove 2610 tapers at one edge. The taper provides a variety of depth at along the contour.

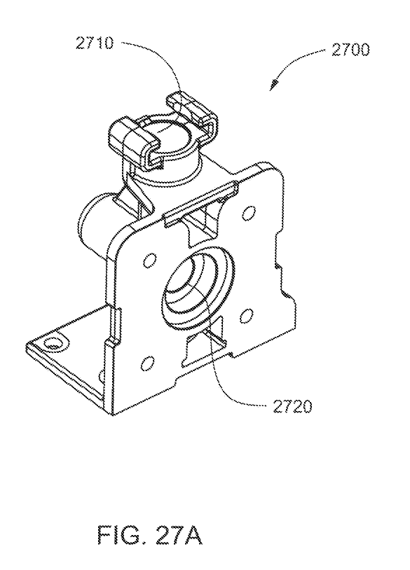

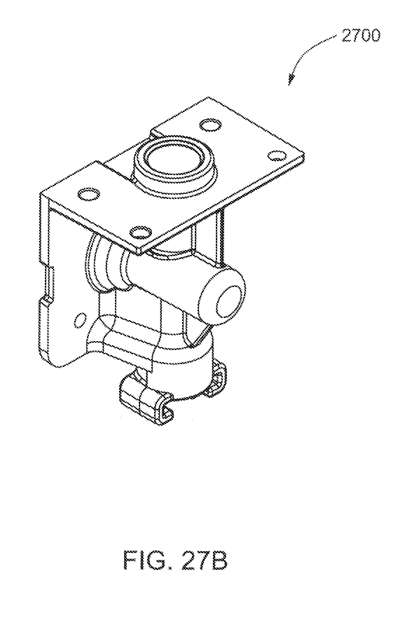

Referring now to FIGS. 27A and 27B, the valve seat member 2700 is shown. In the exemplary embodiment, the valve seat member 2700 includes at least one aperture 2710 which provides a fluid path tangential to the circumference of the seat 2720.

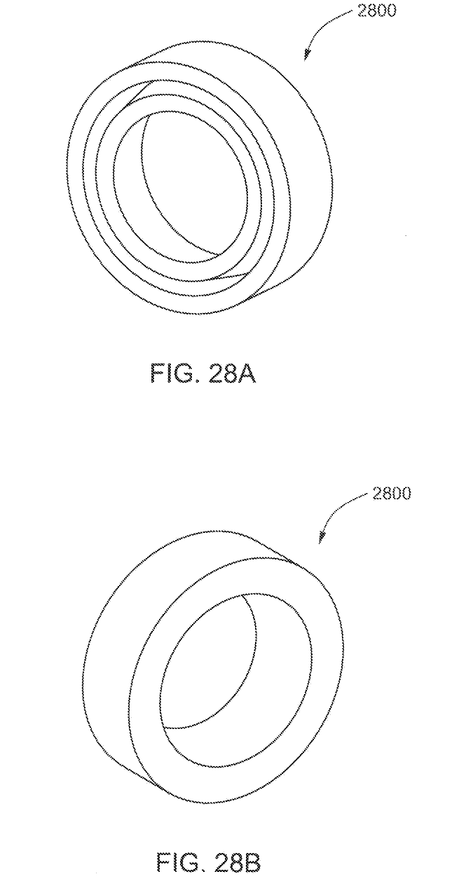

Referring next to FIGS. 28A and 28B, one embodiment of the seal 2800 is shown. In the exemplary embodiment, the seal 2800 is a lip seal and is made from a compliant material.

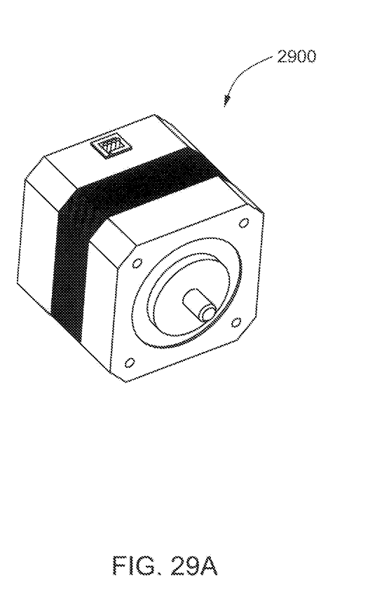

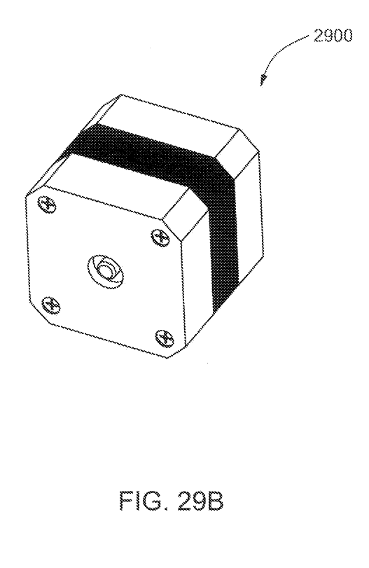

Referring now to FIGS. 29A and 29B, one embodiment of the motor 2900 is shown. In the exemplary embodiment, the motor is a stepper motor. In the preferred embodiment, the stepper motor is an LIN Engineering 4209M-51-02RO, 1.0A.

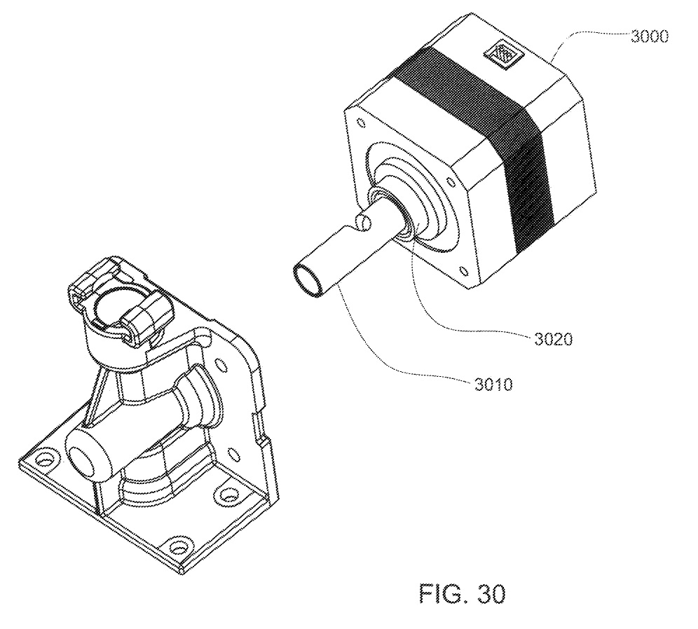

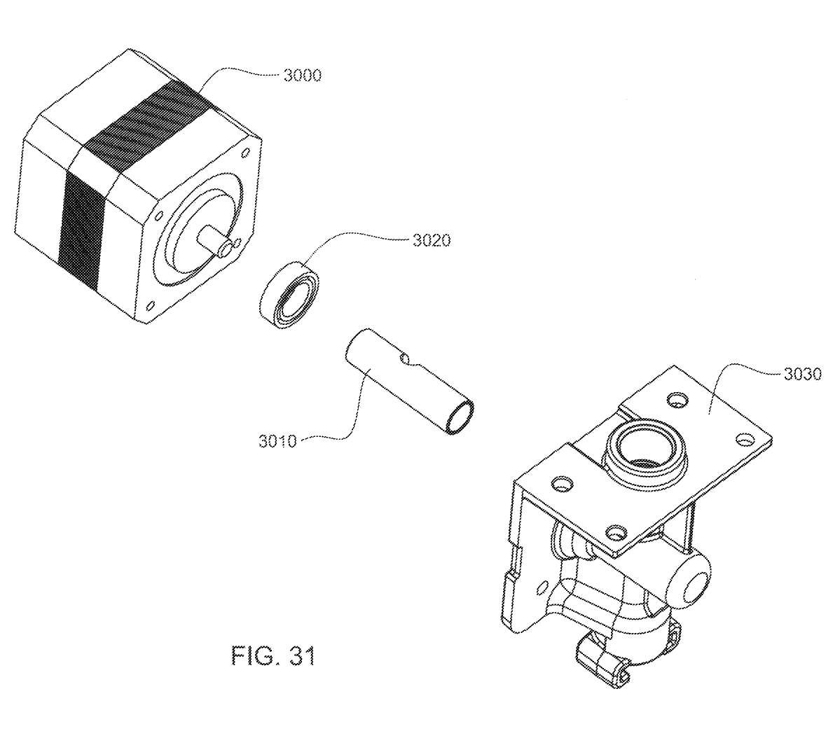

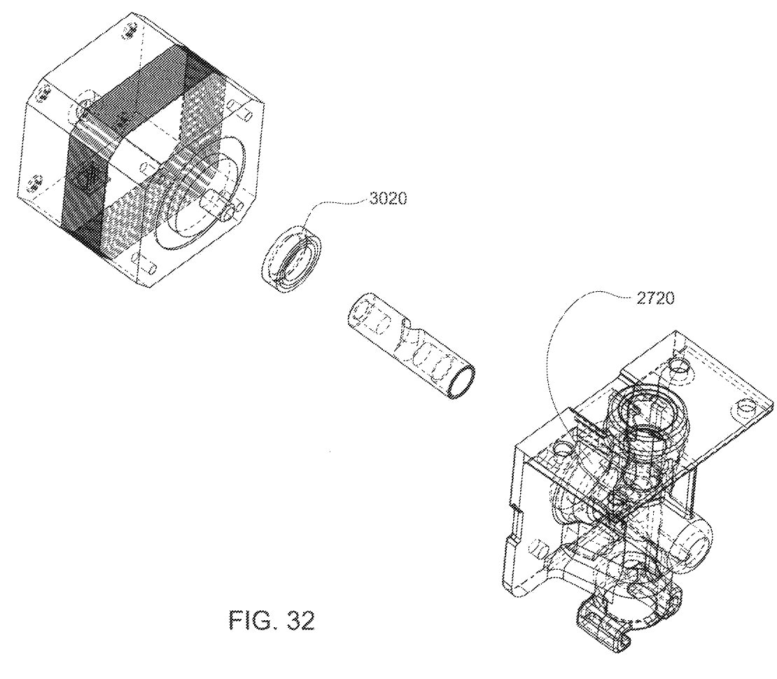

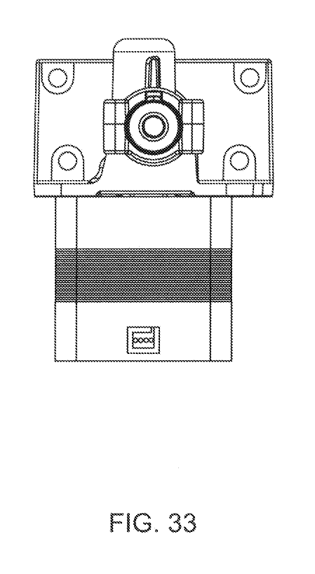

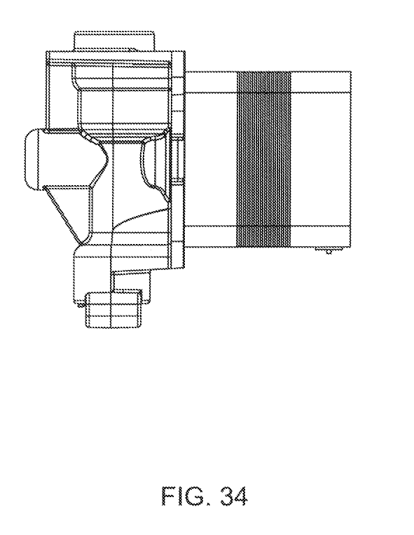

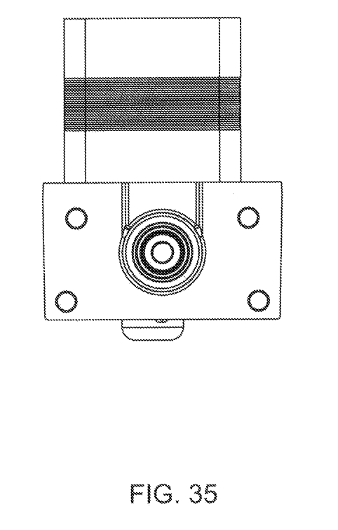

Referring now to FIGS. 30-32, the stopcock valve system is shown. Referring now to FIG. 30, the motor is shown mated to the rigid member 3010. The seal 3020 is shown mated to the rigid member 3010. Referring to FIG. 31, the assembly is fully exploded. The rigid member 3010 will be seated into the valve seat member 3030 at the seat (not shown, shown as 2720 in FIG. 27 and FIG. 32). Referring now to FIG. 32, with the hidden lines view of FIG. 31, the seat 2720 is shown. When fully assembled, as shown in FIGS. 33-35, the seal 3020 seals the seat 2720 so that any fluid will not leak out of the seat 2720.

Referring now to FIGS. 33-35, the fully assembled system is shown.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention.

What is claimed is:

1. A stopcock control valve comprising:
a valve seat member defining a hollow area, said valve seat member having an aperture;
a rigid member having an outer circumferential surface, wherein said outer circumferential surface having a tangential groove defined thereon, said groove tapering at one edge, said tapering comprising sections of varying cross sectional, wherein said rigid member rotatably fits within said hollow area of said valve seat member.

2. The valve claimed in claim 1, further comprising a seal means to seal a space between said valve seat member and said rigid member.

3. The valve claimed in claim 2, wherein the seal means is a lip seal.

4. The valve claimed in claim 2, further comprising a motor operatively connected to said rigid member for rotating said rigid member with respect to said valve seat member.

5. The valve claimed in claim 4, wherein the motor is a stepper motor.

6. The valve claimed in claim 1, further comprising a check valve in said aperture of said valve seat member.

7. The valve claimed in claim 1, wherein said rigid member is made of stainless steel.

8. A stopcock control valve comprising:
a valve seat member defining a hollow area, said valve seat member having an aperture;
a rigid member having an outer circumferential surface, wherein said outer circumferential surface having a tangential groove defined thereon, said groove tapering at one edge, said tapering comprising sections of varying cross section, wherein said rigid member rotatably fits within said hollow area of said valve seat member; and
at least one seal means to seal a space between said valve seat member and said rigid member.

9. The valve claimed in claim 8, wherein the seal means is a lip seal.

10. The valve claimed in claim 8, further comprising a motor operatively connected to said rigid member for rotating said rigid member with respect to said valve seat member.

11. The valve claimed in claim 10, wherein the motor is a stepper motor.

12. The valve claimed in claim 8, further comprising a check valve in said aperture of said valve seat member.

13. The valve claimed in claim 8, wherein said rigid member is made of stainless steel.

14. A stopcock control valve system comprising:
a valve seat member defining a hollow area, said valve seat member having an aperture;
a rigid member having an outer circumferential surface, wherein said outer circumferential surface having a tangential groove defined thereon, said groove tapering at one edge, said tapering comprising sections of varying cross sections, wherein said rigid member rotatably fits within said hollow area of said valve seat member;
at least one seal means to seal a space between said valve seat member and said rigid member; and
a motor operatively connected to said rigid member for rotating said rigid member with respect to said valve seat member.

15. The valve claimed in claim 14, wherein the seal means is a lip seal.

16. The valve claimed in claim 14, wherein the motor is a stepper motor.

17. The valve claimed in claim 14, further comprising a check valve in said aperture of said valve seat member.

18. The valve claimed in claim 14, wherein said rigid member is made of stainless steel.
